(19) United States
(12) Patent Application Publication
(10) Pub. No.: US 2017/0371224 A1
(43) Pub. Date: Dec. 28, 2017

(54) ELECTRICALLY CONTROLLED INTERFERENCE COLOR FILTER AND THE USE THEREOF

(71) Applicant: FRAUNHOFER-GESELLSCHAFT ZUR FÖRDERUNG DER ANGEWANDTEN FORSCHUNG E.V., München (DE)

(72) Inventors: Arno SEEBOTH, Berlin (DE); Detlef LÖTZSCH, Berlin (DE); Christian RABE, Berlin (DE); Peter FRACH, Radeberg (DE); Matthias GITTNER, Dresden (DE); Hagen BARTZSCH, Dresden (DE); René DE LA BARRÉ, Mittweida (DE); Roland BARTMANN, Berlin (DE); Michael VERGÖHL, Cremlingen (DE); Stefan BRUNS, Cremlingen (DE); Thomas NEUBERT, Wolfsburg (DE); Johanna FISCHER, Hellmitzheim (DE); Gerhard SCHOTTNER, Heilsbronn (DE)

(73) Assignee: FRAUNHOFER-GESELLSCHAFT ZUR FÖRDERUNG DER ANGEWANDTEN FORSCHUNG E.V., München (DE)

(21) Appl. No.: 15/540,097

(22) PCT Filed: Dec. 13, 2015
(86) PCT No.: PCT/EP2015/079512

§ 371 Date: Jun. 27, 2017

(30) Foreign Application Priority Data
Jan. 14, 2015 (DE) 102015200488.0

(51) Int. Cl. G02F 1/21; C09K 19/04; G02F 1/1337; G02B 6/293; G02F 1/1347; C08F 220/22; G02F 1/139

(52) U.S. Cl. CPC G02F 1/216; G02F 1/133711; C09K 19/04; G02B 6/29358; C08F 220/22; G02F 1/133788; G02F 1/1393; G02F 2001/13478

(57) ABSTRACT

The invention relates to an electrically controlled interference colour filter comprising at least two transparent electrodes, at least one nematic liquid crystal layer and alignment layers for alignment of the liquid crystals. When an electrical field is applied the liquid crystals can be realigned and thus the transmission wavelength range of the interference colour filter can be shifted.

The invention relates to an electrically controllable interference colour filter which has at least two transparent electrodes, at least one nematic liquid crystal layer and also orientation layers for orientation of the liquid crystals. By applying an electrical field, reorientation of the liquid crystals and hence, accompanying this, displacement of the transmission wavelength range of the interference colour filter can be effected.

In general, there are two types of colour filters: interference- and absorption filters. Electrically controllable colour filters are based exclusively on the interference principle. The mode of operation and optical characteristics of the already known types of interference colour filter differ however significantly in part. Electrically controllable colour filters based on the Lyot principle are commercially available under the name “VariSpec filter” by the company LOT. A Lyot filter consists of a layer structure of a birefringent material and a subsequent polarisation filter. Provided the radiated light is not already polarised linearly, an additional polarisation filter precedes it. Single-stage Lyot filters are neither practicable nor commercially available. The more Lyot filters which are connected in succession, the greater the free spectral range becomes. In the case of “VariSpec filters”, liquid crystal cells are used as electrically controllable birefringent materials and typically 12 or more Lyot filters are connected in succession to form a filter stack. As a condition of the construction, a filter thickness results therefrom of several centimetres (typically 1.5 inch=3.8 cm). The complex method of construction and long switching times (>50 ms) are further disadvantages of the “VariSpec filter”. In DE 3727655 A1, an electrically controllable colour modulation filter is described, which comprises a ferroelectric liquid crystal material with a chiral smectic C-phase. By reorientation of the ferroelectric liquid crystal in the electrical field, in fact the transmission of the described colour modulation filter changes in the visible spectral range, sensitive to the wavelength, without however achieving effective blocking at a specific wavelength. Colour filters based on helical cholesteric LC arrangements, as are described for example in US 2003/0075721 A1 or US 2008/0030635 A1, and all mechanically controllable colour filters, as described for example in U.S. Pat. No. 3,693,115, are not practicable for moving images.

Starting herefrom, it was the object of the present invention to provide an electrically controllable interference colour filter in which use of a polarisation filter can be dispensed with and the transmission of unpolarised light can be influenced by electrical control.

This object is achieved by the electrically controllable interference colour filter having the features of claim 1. In claims 13 and 14, uses according to the invention are indicated.

According to the invention, an electrically controllable interference colour filter which has at least two transparent electrodes, at least one orientation layer and also a nematic liquid crystal layer is provided. The nematic liquid crystal layer and the at least one orientation layer are in direct contact in order to enable orientation of the liquid crystals. By applying an electrical field, the transmission wavelength range of the interference colour filter can be displaced by reorientation of the liquid crystals in the nematic liquid crystal layer.

The nematic liquid crystal layer preferably has a layer thickness in the range of 100 nm to 1,000 nm, in particular of 500 to 900 nm. The spacing between two adjacent resonance lines of the interference colour filter is thereby inversely proportional to the layer thickness of the nematic liquid crystal layer and of the at least one orientation layer. In order to achieve a sufficiently wide free spectral range between two resonance lines in the visible range, this layer thickness must necessarily be less than 2λ/n.

In principle, all nematic liquid crystal structures or mixtures thereof are suitable as liquid crystal: preferred structures are biphenyls, terphenyls, quaterphenyls and tolanes, such as e.g. cyano-, fluoro-, isothiocyanates of biphenylene, terphenylene, quaterphenylene, tolanes or mixtures hereof. Since the wavelength shift of the filter is increased with increasing Δn=nₑ−n₀, the difference between nₑ and n₀ should be as large as possible. A numerical value of at least 5% should be aspired to, this is preferably 10% and more.

Selection of the nematic phase with a positive or negative dielectric constant is, for the person skilled in the art, obviously associated directly with a homogeneously planar or vertical orientation of the liquid crystal in off-mode (see inter alia M. Schadt et al., Nature, 381, 212, 1996; or A. Seeboth, Displays, 20, 131, 1999). The orientation layer is preferably monomolecular. The spacing between the dielectric reflective layers (103), which is composed of the thicknesses of the liquid crystal layer (106) and the orientation layer(s) (105), must, corresponding to optical laws (C. K. Madsen and J. H. Zhao, Optical Filter Design and Analysis, John Wiley & Sons, Inc. 1999), be equal to/less than 2λ/n for a colour filter. With an increase in the layer thickness of the orientation layer, the colour filter effect is correspondingly negatively influenced. Furthermore, the orientation layer is preferably bonded chemically covalently to the adjacent solid body surface, as is described for non-monomolecular orientation layers already in U.S. Pat. No. 4,842,375. For monomolecular orientation layers, a chemical surface fixing represents an additional requirement. For fixing the orientation layer to the metal oxide surface (e.g. SiO₂, Ta₂O₅, Nb₂O₅ or TiO₂), chemically active functional groups F, such as O—, COO—, NH₂—, SiX₄—, Si(OX)₄— or SiXn(OX)₄-n group (X═H, CH₃, C₂H₅, halogen, such as F, Cl, Br, I) are absolutely necessary, on the one hand, which groups can react e.g. with the Si—O—Si or Ti—O—Ti groupings in the reflective layer to form covalent bonds, as described in detail in H. H. Dunken et al., Physikalische Chemie der Glasoberfläche (Physical Chemistry of the Glass Surface), VEB German Press for Basic Material Industry 1981. On the other hand, these structural units with the functional groups must influence negatively neither the topography nor the interface tension of the orientation layer γOS. Homogeneous orientation of the liquid crystal and hence a sufficient degree of order would otherwise no longer be ensured. A filling process of the nematic liquid crystal via capillary force would likewise not be possible. According to the invention, the interface tension of the orientation layer γOS and that of the liquid crystal γLC, which can both be determined in the known manner (A. Seeboth et al., Colloids and Surfaces A, 78, 177, 1993), is preferably most extensively identical: Δγ=γOS−γLC≈0.

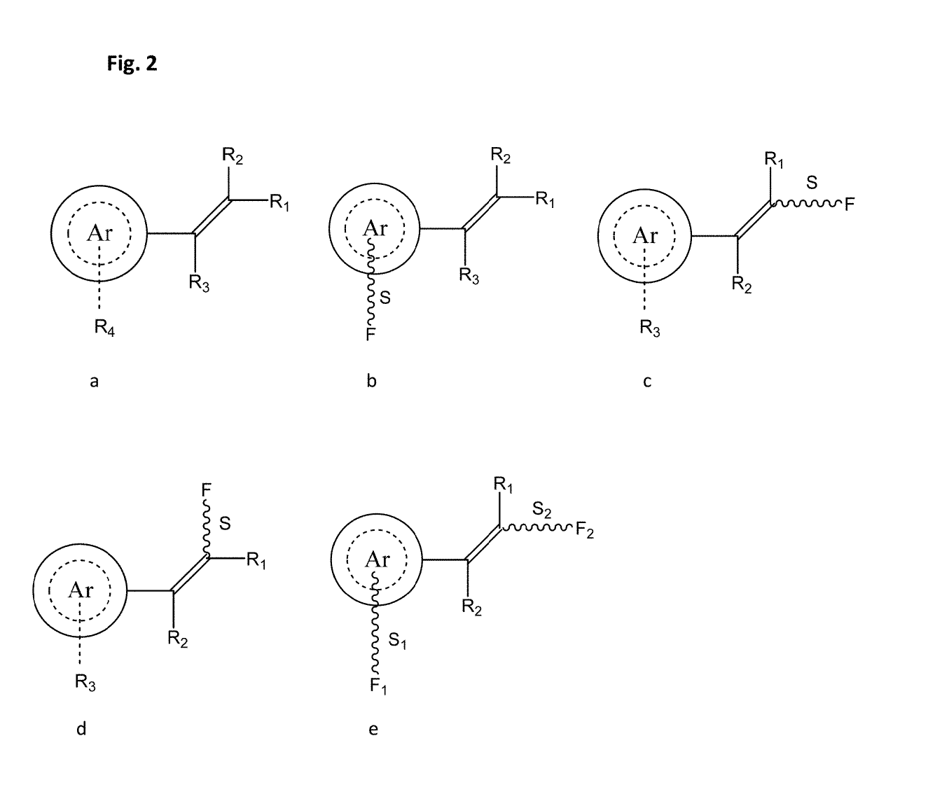

Suitable basic structures for the orientation layer are compounds with photoreactive ethene groups, such as coumar-, phenylacryl-, 3-(2-furyl)acryl-, 3-(2-thienyl)acryl- and trans-stilbene derivatives, as shown in FIG. 2a, in which Ar stands for phenyl, naphthyl, anthryl, furyl, thienyl or any other aromatic. However for fixing the orientation layer to the metal oxide surface, this basic structure requires in addition further additional functional groups F which are coupled via spacer S either to the aromatic core, as in FIG. 2b, or to any point of the aliphatic part of the main molecule, as for example in FIG. 2c. It is evident that the spacer in FIG. 2c can also be bonded alternatively at other places, e.g. as in FIG. 2d. Furthermore, all possible further combinations can be used for the molecule design, such as for example a coupling both to the aliphatic and to the aromatic molecule part, as shown in FIG. 2e. The substituents denoted in FIGS. 2a-2e as R1, R2, R3, R4 stand for example for hydrogen, halogen (F, Cl, Br, I), alkyl, alkyloxy, cycloalkyl, phenyl, naphthyl, anthryl, furyl, thienyl or any other aromatic. The spacer S is preferably a hydrocarbon chain with 2-8 carbon atoms, which can be interrupted for example by means of amide-, ether- or ester bridges. The functional group F is preferably a O—, COO—, NH2—, SiX4—, Si(OX)4— or SiXn(OX)4-n group (X═H, CH3, C2H5, halogen such as F, Cl, Br, I).

Each substituent R1, R2, R3, R4 can occur either only per se or in any combination between R1, R2, R3, R4.

Preferably, the nematic liquid crystal layer is in direct contact at both surfaces with respectively one orientation layer.

Furthermore, it is preferred that the interference colour filter has a distance layer which has at least one recess which receives the nematic liquid crystal layer. Hence, the layer thickness of the nematic liquid crystal layer can be adjusted via the distance layer. The distance layer is thereby preferably produced in the sputtering process, as a result of which the layer thickness of the distance layer can be adjusted with precision in the single-digit nm range.

A further preferred embodiment provides that the interference colour filter has at least one dielectric reflective layer.

The dielectric reflective layer consists preferably of alternate pairs of layers of a low-refractive and a high-refractive material, n being a whole positive number. As low-refractive material, e.g. SiO₂ with a refractive index of 1.46 at 589 nm and, as high-refractive material, Ta₂O₅, Nb₂O₅ or TiO₂ with refractive indices between 2.15 and 2.45 at 589 nm can be used. Selection of the mentioned dielectric materials is optimised for the visible spectral range.

For the arrangement of the dielectric reflective layers there are three variants. In the case of the first variant, the dielectric reflective layer can be disposed on the side of the transparent electrode which is orientated towards the nematic liquid crystal layer. A second variant provides that the dielectric reflective layer is disposed on the side of the transparent electrode which is orientated away from the nematic liquid crystal layer and a third variant relates to integration of the transparent electrodes in the dielectric reflective layers.

It is preferred that the transparent electrodes comprise a transparent electrically conductive material or consist hereof.

Examples of this are indium-tin oxide (ITO), aluminium-doped zinc oxide (AZO), fluorine-tin oxide (FTO), antimony-tin oxide (ATO), graphene, silver nanowires and carbon nanotubes.

The subject according to the invention is intended to be explained in more detail with reference to the subsequent Figures and examples without wishing to restrict said subject to the specific embodiments shown here.

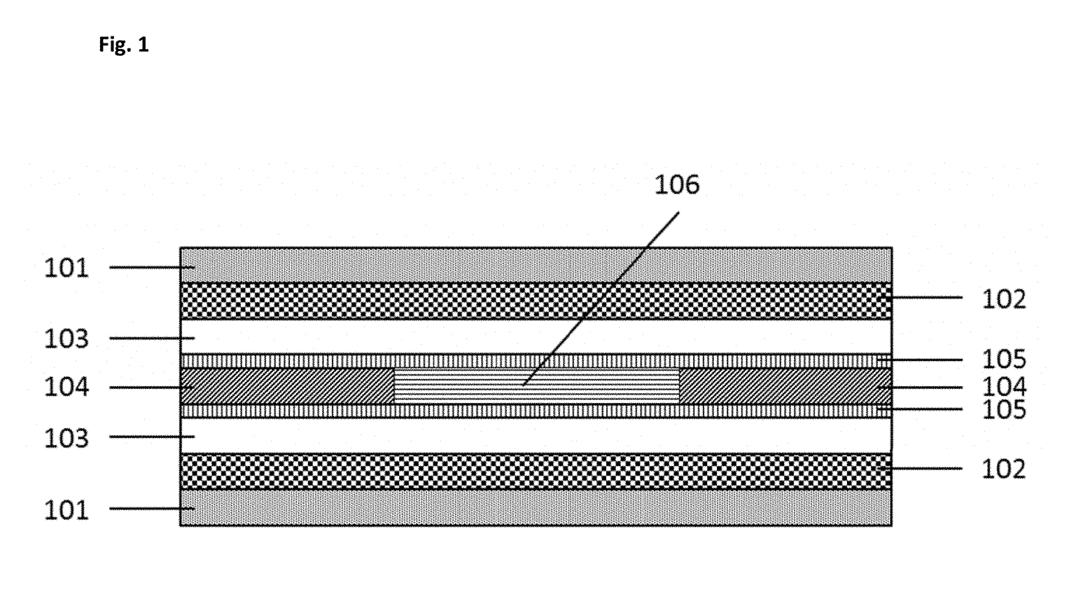

FIG. 1 shows the schematic construction of an interference colour filter according to the invention.

FIG. 2 shows various structures for components used according to the invention for the orientation layer.

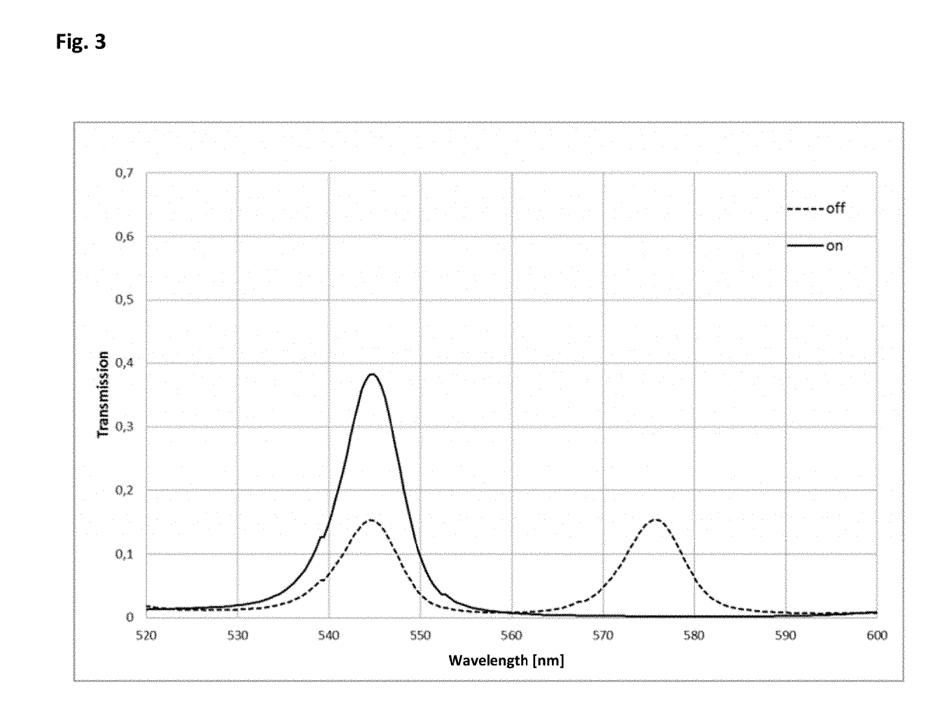

FIG. 3 shows, with reference to a diagram, the displacement of the transmission range of an interference colour filter according to the invention in a spectral range not used for light transmission.

In FIG. 1, an interference colour filter according to the invention is illustrated, which filter has two orientation layers (105) and (105′), between which a nematic liquid crystal layer (106) is disposed. The thickness of the nematic liquid crystal layer (106) is thereby defined by the surrounding distance layer (104). On the side of the orientation layers (105) and (105′) which is orientated away from the nematic liquid crystal layer (106), the dielectric reflective layers (103) and (103′) are respectively disposed. On these in turn, the transparent electrodes (102) and (102′) are deposited. In addition, the interference colour filter according to the invention also has outer carrier layers (101) and (101′).

### EXAMPLE 1

Example 1 relates to an electrically controllable interference colour filter designed for green light with a wavelength of 575 nm.

For the example, commercial ITO glasses of the company Präzisions Glas & Optik GmbH (CEC050P) were used with a surface resistance of 40 Ω/□. The transmission of the ITO glass is 80% at 450 nm and 87% at 700 nm. Two of these ITO glasses are coated respectively with a dielectric reflective layer (103) which is designed for a wavelength of 575 nm. The dielectric reflective layer consists of four SiO₂— and four Ta₂O₅ layers which are sputtered on in an alternate layer sequence starting with SiO₂ (S[HL]̂4 H-575 nm).

On the first of the two produced ITO glasses with reflective layer, trans-3-(3-(5-chloropentyloxy)phenyl)acrylic acid phenyl ester is subsequently bonded, in the immersion process, covalently to the reflective layer surface, as a result of which a monomolecular organic layer with photoreactive ethene groups is formed. By photochemical crosslinking with linear polarised light, the structured surface of the orientation layer (105) is produced therefrom. Elipsometric measurements show that the thickness of the orientation layer, as to be expected for a monomolecular layer, is below the detection limit of 2 nm, as a condition of the process.

On the second ITO glass provided with the reflective layer, the distance layer (104) is applied in the form of two webs on opposite ends of the substrate. A recess is thereby produced in the centre of the substrate and, after assembly of the two half-cells (ITO glass+reflective layer+orientation layer/ITO glass+reflective layer+distance layer), forms the cavity into which the liquid crystal layer (106) is filled. In order to be able to adjust exactly the ultrathin distance layer (104) and hence the resulting ultrathin liquid crystal layer (106), the distance layer is produced in the sputtering process, the cavity surface being covered by a mask. For the present embodiment, SiO₂ was sputtered on with a layer thickness of 753 nm. A LC layer is produced with analogously 753 nm.

Both half-cells (ITO glass+reflective layer+orientation layer/ITO glass+reflective layer+distance layer) are joined, plane-parallel, according to a conventional LCD-assembly technique, to form the interference filter.

The cavity of the interference filter is filled with a nematic liquid crystal in the last step. In the present embodiment, a eutectic liquid crystal mixture was used of this purpose, which mixture has a nematic phase with Δn=6% at room temperature and the interface tension of which is adapted to that of the orientation layer, Δγ=γOS−γLC=0.8 mN/m.

The thus produced colour filter can be connected to the ITO electrodes thereof by applying a voltage of 11 V. The switching times of the colour filter are, with tₒₙ=580 μs and, for t_{off}=1.33 ms, in the μs/ms range. If a monochromatic or narrow-band light (LED or laser diode) with a central wavelength of 575 nm is used as backlight, the switching effect of the cell is associated with a switching effect which is clearly visible to the naked eye of green to black. In the “off” state, the colour filter is transparent for light of wavelength 575 nm, whereas, in the “on” state, the backlight is blocked practically completely. The transmission wavelength in the “on” state is in the unused spectral range. The transmission spectra of the colour filter in the “off” and “on” state for the wavelength range of 520 nm to 600 nm are shown in image 3. These spectra were measured with nonpolarised light. In the “off” state, the colour filter has, in the observed wavelength range, two transmission peaks with maxima at 545 nm and 575 nm. The range therebetween is defined as free spectral range. As a function of the applied voltage, the peak is displaced continuously from 575 nm to 545 nm.

### EXAMPLE 2

Example 2 is an electrically controllable interference colour filter designed for blue light with a wavelength of 450 nm. Embodiment 2 was produced analogously to embodiment 1. For adaptation to the changed transmission wavelength, firstly the thickness of the SiO₂ and Ta₂O₅ layers of the reflective layer (103) was changed to 76.36 nm (SiO₂)/51.07 nm (Ta₂O₅) and secondly the thickness of the spacer layer to 558 nm. The thus produced colour filter switches at a voltage of 9.2 V at the ITO electrodes thereof. With a monochromatic backlight, the colour filter switches from blue to black. Likewise as in embodiment 1, the switching effect is clearly visible with the naked eye.

### EXAMPLE 3

Example 3 is an electrically controllable interference colour filter designed for red light with a wavelength of 632 nm. Embodiment 3 was likewise produced analogously to embodiment 1 with adaptation of the thickness of the SiO₂ and Ta₂O₅ layers to 95.53 nm (SiO₂)/64.12 (Ta₂O₅) of the reflective layer and of the thickness of the spacer layer to 798 nm. The thus produced colour filter switches at a voltage of 11.9 V at the ITO electrodes thereof. With a monochromatic backlight, the colour filter switches from red to black. Likewise as in embodiments 1 and 2, the switching effect is clearly visible with the naked eye.

It is evident to the person skilled in the art that, by changing the selection of the nematic liquid crystal (variation of Δn, Δε, viscosity) of the reflective layer configuration and layer materials (number of pairs of reflective layers, layer thicknesses and dielectric properties of the layers), the thickness of the liquid crystal layer, chemical structure of the monomolecular orientation layer (variation in the interface properties), the switching time and threshold voltage of the electrically controllable filter can be displaced both to higher and to lower values. It is likewise evident that the maximum displacement range of the wavelength is determined by Δn and the used displacement range can be controlled variably via the voltage. The embodiments can be used as single filter or as RGB filter, also in matrix form.

1-14. (canceled)

15. An electrically controllable interference colour filter, comprising at least two transparent electrodes, at least one orientation layer and a nematic liquid crystal layer, the nematic liquid crystal layer and the at least one orientation layer are in direct contact for orientation of the liquid crystals wherein, the transmission wavelength range of the interference colour filter is displaceable by applying an electrical field or by reorientation of the liquid crystals.

16. The interference colour filter according to claim 15,
wherein the nematic liquid crystal layer has a layer thickness in the range of 100 nm to 1,000 nm.

17. The interference colour filter according to claim 15,
wherein the nematic liquid crystal layer comprises liquid crystals selected from the group consisting of biphenyls, terphenyls, quaterphenyls, and tolanes.

18. The interference colour filter according to claim 15,
wherein the nematic liquid crystal layer is in direct contact at both surfaces with respectively one orientation layer.

19. The interference colour filter according to claim 15,
wherein the at least one orientation layer is selected from the group consisting of photoreactive ethene groups, coumar-, phenylacryl-, 2-(2-furyl)acryl-3-(2-thienyl)acryl- and trans-stilbene derivatives.

20. The interference colour filter according to claim 15,
wherein the at least one orientation layer is monomolecular and bonded chemically covalently to the at least one dielectric reflective layer.

21. The interference colour filter according to claim 15,
wherein the interface tension of the at least one orientation layer corresponds to the interface tension of the nematic liquid crystal layer, with a difference in interface tension of at most 1 mN/m.

22. The interference colour filter according to claim 15,
wherein the interference colour filter has a distance layer and has at least one recess which receives the nematic liquid crystal layer.

23. The interference colour filter according to claim 15,
wherein the interference colour filter has at least one dielectric reflective layer.

24. The interference colour filter according to claim 23,
wherein the at least one dielectric reflective layer consists of a several pairs of layers made of a material with a refractive index<1.5 and a material with a refractive index>2.0.

25. The interference colour filter according to claim 23,
wherein the dielectric reflective layers are integrated on the side of the transparent electrodes which is orientated towards the nematic liquid crystal layer, on the side of the transparent electrodes which is orientated away from the nematic liquid crystal layer or the transparent electrodes are integrated in the dielectric reflective layers.

26. The interference colour filter according to claim 15,
wherein the transparent electrodes comprise a transparent electrically conductive material or consist thereof.

27. The interference colour filter according to claim 24,
wherein the material with a refractive index<1.5 is SiO₂ and the material with a refractive index>2.0 is Ta₂O₅, Nb₂O₅ or TiO₂.

28. The interference colour filter according to claim 26,
wherein the transparent electrically conductive material is selected from the group consisting of indium-tin oxide (ITO), aluminium-doped zinc oxide (AZO), fluorine-tin oxide (FTO), antimony-tin oxide (ATO), graphene, silver nanowires, and carbon nanotubes.

29. The interference colour filter according to claim 17,
wherein the nematic liquid crystal layer comprises liquid crystals selected from the group consisting of substituted cyano, fluoro-, isothiocyanates of biphenylene, terphenylene, quaterphenylene or tolanes.
